(19) United States
(12) Patent Application Publication
(10) Pub. No.: US 2012/0092684 A1
(43) Pub. Date: Apr. 19, 2012

(54) PRINTING DEVICE AND PRINTING METHOD

(75) Inventors: Takamitsu KONDO, Shiojiri (JP); Toru TAKAHASHI, Azumino (JP); Hiroshi WADA, Azumino (JP); Kazuyoshi TANASE, Matsumoto (JP)

(73) Assignee: SEIKO EPSON CORPORATION, Tokyo (JP)

(21) Appl. No.: 13/271,484

(22) Filed: Oct. 12, 2011

(30) Foreign Application Priority Data
Oct. 14, 2010 (JP) 2010-231411

(51) Int. Cl. G06K 15/02

(52) U.S. Cl. 358/1.2; 358/1.9

(57) ABSTRACT

The invention includes a dot formation section having nozzle rows of lined up nozzles, and adapted for forming a plurality of dot lines of a plurality of lined-up dots by ejecting ink from the nozzle rows while bringing about relative movement of the nozzle rows and a medium; a detection section for detecting dot width in a given dot line; and a correction value adjustment section for comparing dot width detected by the detection section and dot width stored in a storage section, and respectively correcting concentration correction values in the correction data according to the comparison results.

### CROSS-REFERENCE TO RELATED APPLICATIONS

This application claims priority to Japanese Patent Application No. 2010-231411 filed on Oct. 14, 2010. The entire disclosure of Japanese Patent Application No. 2010-231411 is hereby incorporated herein by reference.

### BACKGROUND

1. Technological Field

The present invention relates to a printing device and a printing method.

2. Background Technology

When an image is formed on a medium (e.g., paper) by a printing device such as an inkjet printer for example, banded density variations sometimes occur in the image. In this regard, a well-known device is provided to print out a correction pattern for each ink color using the printing device, scan the correction patterns with a scanner or the like, calculate concentration correction values based on the color information obtained as a result, and carry out correction of density (see Patent Citation 1, for example).

Japanese Patent Application Publication No. 2005-205691 (Patent Citation 1) is an example of the related art.

### SUMMARY

### Problems to Be Solved by the Invention

The form which density variations take may differ depending on printing conditions. For example, with different types of media, it is possible that for a given amount of ejected ink, dots of different size (dot width) will be formed by nozzles. In this case, density variations may take different forms, posing a risk that it will not be possible to minimize density variations even where concentration correction values calculated in the above manner are used. Moreover, recreating new data relating to concentration correction values (correction data) for every set of printing conditions would be time-consuming and laborious.

Accordingly, it is an object of the invention to create correction data for minimizing density variations, while reducing the time and labor involved.

### Means Used to Solve the Above-Mentioned Problems

The principal invention for attaining the aforedescribed object resides in a printing device characterized by comprising a dot formation section having nozzle rows in which a plurality of nozzles line up in a predetermined direction, the dot formation section adapted for ejecting ink from the nozzle rows while relative movement of the nozzle rows and a medium is brought about in a direction of relative movement which intersects the predetermined direction, thereby forming in the predetermined direction a plurality of dot lines in which a plurality of dots line up in the direction of relative movement; a detection section for detecting dot width in the predetermined direction in a given dot line; a storage section for storing correction data which defines concentration correction values for dot lines, and dot width of the given dot line in the predetermined direction at the time of creation of the correction data; and a correction value adjustment section for comparing dot width detected by the detection section with dot width stored in the storage section, and respectively correcting concentration correction values in the correction data according to the comparison results.

These and other features of the invention will be appreciated from the disclosure of the present specification and accompanying drawings.

### BRIEF DESCRIPTION OF THE DRAWINGS

Referring now to the attached drawings which form a part of this original disclosure:

FIG. 1 is a block diagram showing a configuration of a printing system;

FIG. 2 is a perspective view for describing a conveyance process and a dot formation process of a printer;

FIG. 3 is an illustrative diagram of an array of a plurality of heads on the bottom face of a head unit;

FIG. 4 is an illustrative diagram of head disposition and dot formation, for simple descriptive purposes;

FIG. 5 is an illustrative diagram of processing by a printer driver;

FIG. 6A is an illustrative diagram of ideal formation of raster lines; FIG. 6B is an illustrative diagram of the occurrence of density variations; and FIG. 6C is a view showing minimized occurrence of density variations;

FIG. 7 is a diagram showing a flow of a correction value acquisition process;

FIG. 8 is an illustrative diagram of a correction pattern CP;

FIG. 9 is a graph showing computed densities of every raster line for sub-patterns CSP;

FIG. 10A is an illustrative diagram of a routine for calculating a concentration correction value Hb for the purpose of correcting a directive tone value Sb for an i-th raster line; and FIG. 10B is an illustrative diagram of a routine for calculating a concentration correction value Hb for the purpose of correcting a directive tone value Sb for a j-th raster line;

FIG. 11 is a diagram showing correction value tables;

FIG. 12 is a diagram showing data in a correction value table;

FIG. 13 is a schematic diagram showing wetting and spreading of ink; and

FIG. 14 is a flowchart showing a correction value table revision method according to the embodiment.

### DETAILED DESCRIPTION OF EXEMPLARY EMBODIMENTS

At a minimum, the following matters will be appreciated from the disclosure of the present specification and accompanying drawings.

There will be appreciated a printing device characterized by comprising a dot formation section having nozzle rows in which a plurality of nozzles line up in a predetermined direction, the dot formation section adapted for ejecting ink from the nozzle rows while relative movement of the nozzle rows and a medium is brought about in a direction of relative movement which intersects the predetermined direction, thereby forming in the predetermined direction a plurality of dot lines in which a plurality of dots line up in the direction of relative movement; a detection section for detecting dot width in the predetermined direction in a given dot line; a storage section for storing correction data which defines concentration correction values for dot lines, and dot width of the given dot line in the predetermined direction at the time of creation of the correction data; and a correction value adjustment section for comparing dot width detected by the detection section with dot width stored in the storage section, and respectively correcting concentration correction values in the correction data according to the comparison results.

According to this printing device, correction data for minimizing density variations can be created, while reducing the time and labor involved.

In the printing device, in preferred practice the correction value adjustment section, in cases where a dot width detected by the detection section is greater than a dot width stored in the storage section, corrects the concentration correction values in the correction data such that the dot lines assume lighter density; and in cases where a dot width detected by the detection section is less than a dot width stored in the storage section, corrects the concentration correction values in the correction data such that the dot lines assume darker density.

According to this printing device, density variations can be reduced.

In the printing device, in preferred practice, in cases where a dot width detected by the detection section is greater by a predetermined value than a dot width stored in the storage section, the amount of correction of concentration correction values is less than the amount of correction of concentration correction values in cases where a dot width detected by the detection section is less by the predetermined value than a dot width stored in the storage section.

According to this printing device, density variations can be efficiently kept to a minimum.

In the printing device, in preferred practice the amount of correction of concentration correction values is increased for dot lines having a greater differential between density and an average value of density of a plurality of dot lines formed by the dot formation section.

According to this printing device, density variations can be made less noticeable.

In the printing device, in preferred practice, the ink is an ink cured by irradiation with light; and the device further has a light source for irradiating a medium with light prior to detection of dot width of the given dot line by the detection section.

According to this printing device, density variations can be minimized even in cases where ink is not absorbed by the medium.

There will also be appreciated a printing method of a printing device having nozzle rows in which a plurality of nozzles line up in a predetermined direction, wherein ink is ejected from the nozzle rows while relative movement of the nozzle rows and a medium is brought about in a direction of relative movement which intersects the predetermined direction, thereby forming in the predetermined direction a plurality of dot lines in which a plurality of dots line up in the direction of relative movement; wherein the printing method is characterized by comprising: storing in a storage section correction data which defines concentration correction values for dot lines, and dot width of a given dot line in the predetermined direction at the time of creation of the correction data; detecting, using a detection section, dot width in the predetermined direction in the given dot line formed on the medium; comparing dot width detected by the detection section with dot width stored in the storage section, and respectively correcting concentration correction values in the correction data according to the comparison results; and applying the correction data subsequent to correction and carrying out printing on the medium.

### Printing System

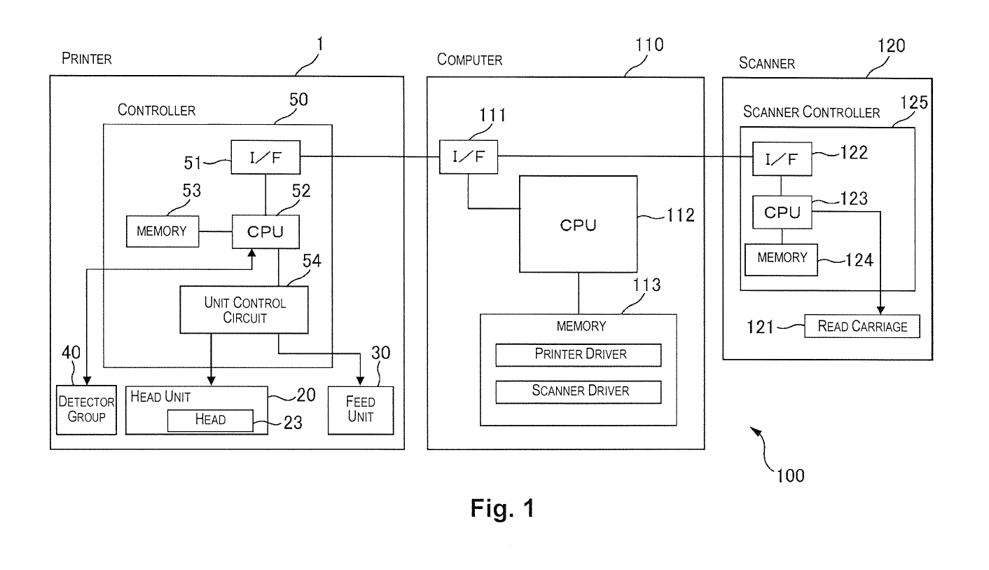

A printing system 100 for forming images on media is outlined with reference to FIG. 1. FIG. 1 is a block diagram showing a configuration of the printing system 100.

As shown in FIG. 1, the printing system 100 of the present embodiment is a system having a printer 1, a computer 110, and a scanner 120.

The printer 1 (equivalent to the dot formation section) is a device for ejecting a liquid onto a medium to form an image (dots) on the medium; in the present embodiment, it is a color inkjet printer. The printer 1 is capable of printing images onto several types of media such as paper, cloth, film sheets, and so on. The configuration of the printer 1 is discussed later.

The computer 110 has an interface 111, a CPU 112, and a memory 113. The interface 111 carries out data transfers with the printer 1 and with the scanner 120. The CPU 112 carries out overall control of the computer 110, and executes various types of programs which have been installed on the computer 110. The memory 113 stores the various types of programs and various types of data. Among the programs installed on the computer 110 are a printer driver for converting image data output by application programs into print data, and a scanner driver for controlling the scanner 120. The computer 110 then outputs the print data generated by the printer driver to the printer 1.

The scanner 120 (equivalent to the detection section) has a scanner controller 125, and a read carriage 121. The scanner controller 125 has an interface 122, a CPU 123, and a memory 124. The interface 122 carries out communication with the computer 110. The CPU 123 carries out overall control of the scanner 120. For example, it controls the read carriage 121. The memory 124 stores computer programs and the like. The read carriage 121 has, for example, three sensors (CCD or the like), not shown, corresponding to R (red), G (green), and B (blue).

By virtue of the configuration above, the scanner 120 irradiates light onto a medium on which an image has been formed by the printer 1, detects reflected light therefrom with sensors of the read carriage 121, scans the image on the medium, and acquires color information of the image in question. It then sends data showing the color information of the image (scan data) to the scanner driver of the computer 110 via the interface 122. While not shown in the drawings, the scanner 120 of the present embodiment is furnished on the conveyance path of the medium through the printer 1 so as to scan an image printed on the medium as the medium is being conveyed. The scanner 120 of the present embodiment also carries out detection of line width of ruled lines (raster lines, discussed later) printed on the medium. The details of this line width detection will be discussed later.

Herein, “printing device” refers in the narrow sense to the printer 1, but in the broad sense refers to the system comprised of the printer 1, the computer 110, and the scanner 120.

### Configuration of Printer 1

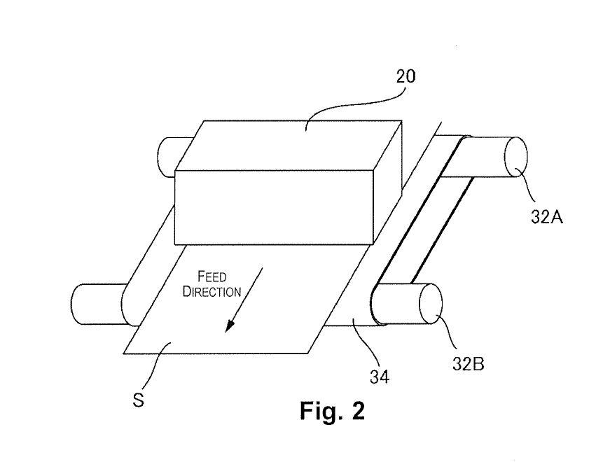

Next, the configuration of the printer 1 will be described with reference to FIGS. 1 and 2. FIG. 2 is a perspective view for describing a conveyance process and a dot formation process in the printer 1.

As shown in FIG. 1, the printer 1 has a head unit 20, a feeding unit 30, a detector group 40, and a controller 50. When the printer 1 receives print data from the computer 110, the controller 50 controls the units (the head unit 20, the feeding unit 30) on the basis of the print data, and prints an image onto a printing medium. Events inside the printer 1 are monitored by the detector group 40, and the detector group 40 outputs signals according to detected results to the controller 50.

The purpose of the head unit 20 is to eject ink onto paper S. By ejecting ink onto the paper S as it is being conveyed, the head unit 20 forms dots on the paper S and prints an image onto the paper S. The printer 1 of the present embodiment is a line printer, and the head unit 20 can form dots equivalent to the width of the paper all at one time.

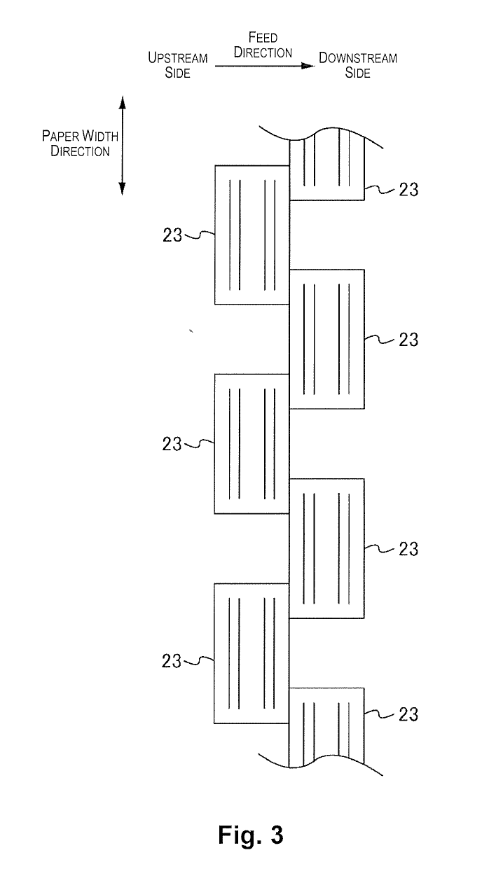

FIG. 3 is an illustrative diagram of an array of a plurality of heads on the bottom face of the head unit 20. As shown in the drawing, a plurality of heads 23 are lined up in a staggered row pattern along the paper width direction. While not shown in the drawing, black ink nozzle rows, cyan ink nozzle rows, magenta ink nozzle rows, and yellow ink nozzle rows are formed in the heads. Nozzle rows are provided with a plurality of nozzles for ejecting ink. The plurality of nozzles of the nozzle rows line up at a constant nozzle pitch along the paper width direction.

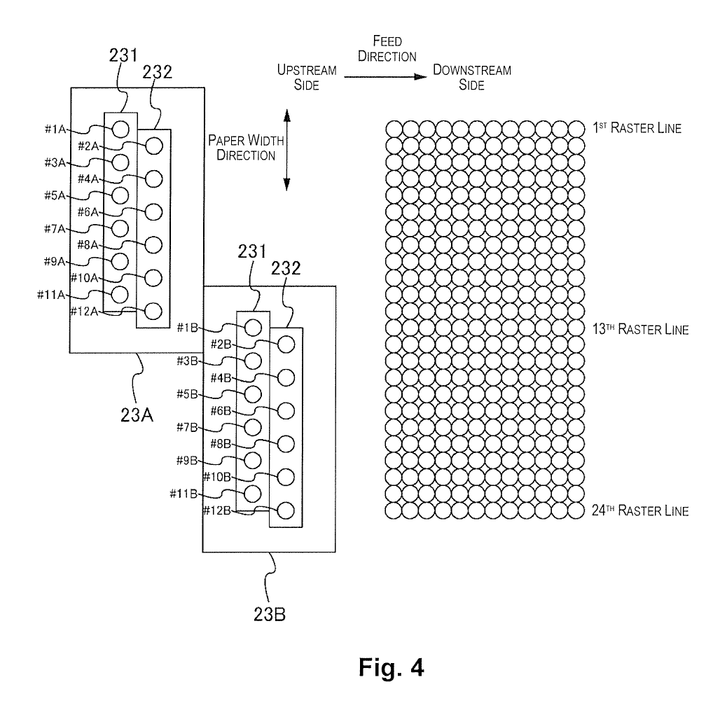

FIG. 4 is an illustrative diagram of head disposition and dot formation, for simple descriptive purposes. Here, for simplicity in description, the head unit 20 is assumed to be comprised of two heads (a first head 23A and second head 23B). Also, for simplicity in description, it is assumed that each head is furnished with nozzle rows for a single color (e.g. black). To further simplify the description, it is assumed that the nozzle rows of the heads are each provided with 12 nozzles.

These nozzle rows form rows of dots lined up in the direction of relative movement of the heads and the medium (the relative movement direction). These rows of dots are referred to as “raster lines (corresponding to dot lines).” In the case of a line printer as in the present embodiment, a “raster line” means a row of dots lined up in the paper feed direction. On the other hand, in the case of a serial printer which prints with heads installed on a carriage, a “raster line” means a row of dots lined up in the direction of movement of the carriage. A printed image is composed by forming a multitude of raster lines lined up in the direction of nozzle lineup. As illustrated in the drawing, a raster line at an n-th position is termed an “n-th raster line.” In the present embodiment, raster lines correspond respectively to single nozzles.

As illustrated in the drawing, the nozzle rows of each of the heads are provided as a first nozzle group 231 and a second nozzle group 232. Each of the nozzle groups is comprised, for example, of six nozzles lined up in the paper width direction at 1/180 inch intervals. The first nozzle group 231 and the second nozzle group 232 are shifted by 1/360 inch in the paper width direction. Because of this, the nozzle rows of the heads constitute nozzle rows comprised of 12 nozzles lined up at 1/360 inch intervals in relation to the paper width direction. The nozzle rows of the heads are numbered in order from the top in the drawing.

Through intermittent ejection of ink drops from the nozzles onto the paper S being conveyed, 24 raster lines are formed on the paper S. For example, a nozzle #1A of the first head 23A forms a first raster line on the paper S, and a nozzle #1B of the second head 23B forms a thirteenth raster line on the paper S. The plurality of raster lines are formed along the conveyance direction.

The purpose of the feeding unit 30 is to convey the medium (e.g., the paper S) in a feed direction. This feeding unit 30 has an upstream roller 32A, a downstream roller 32B, and a belt 34. The upstream roller 32A and the downstream roller 32B are rotated through rotation of a conveying motor, not shown, rotating the belt 34. The supplied paper S is conveyed to a printable area (an area facing the heads) by the belt 34. Through the conveying of the paper S by the belt 34, the paper S moves in the feed direction with respect to the head unit 20. The paper S having passed through the printable area is expelled to the outside by the belt 34. During conveyance, the paper S is retained on the belt 34 through electrostatic attraction or vacuum suction.

The detector group 40 includes a rotary encoder (not shown), a paper detection sensor (not shown), and so on. The rotary encoder detects the amount of rotation of the upstream conveying roller 32A and the downstream conveying roller 32B. The amount of conveyance of the medium can be detected based on the detection results of the rotary encoder. The paper detection sensor detects the position of the leading edge of the medium during supply.

The controller 50 controls the units of the printer 1 with the CPU 52 via a unit control circuit 54. The printer 1 also has a memory 53 (equivalent to the storage section) provided with storage elements, with a correction value table for the purpose of correcting the density of the raster lines stored in the memory 53. The correction value table will be discussed in detail below.

### Printing Process

With this printer 1, when the controller 50 receives print data, first, the controller 50 initiates rotation of a paper supply roller (not shown) by the feeding unit 30, and feeds the paper S to be printed onto the belt 34. The paper S is conveyed on the belt 34 at a constant speed without stopping, and passes under the head unit 20. As the paper S passes under the head unit 20, ink is ejected intermittently from the nozzles of the first head 23A and the second head 23B. That is, the dot formation process and the conveying process of the paper S are carried out simultaneously. As a result, an image composed of a plurality of dots along the feed direction and the paper width direction is printed onto the paper S. Finally, the controller 50 then expels the paper S once printing of the image is finished.

### Overview of Processing by the Printer Driver

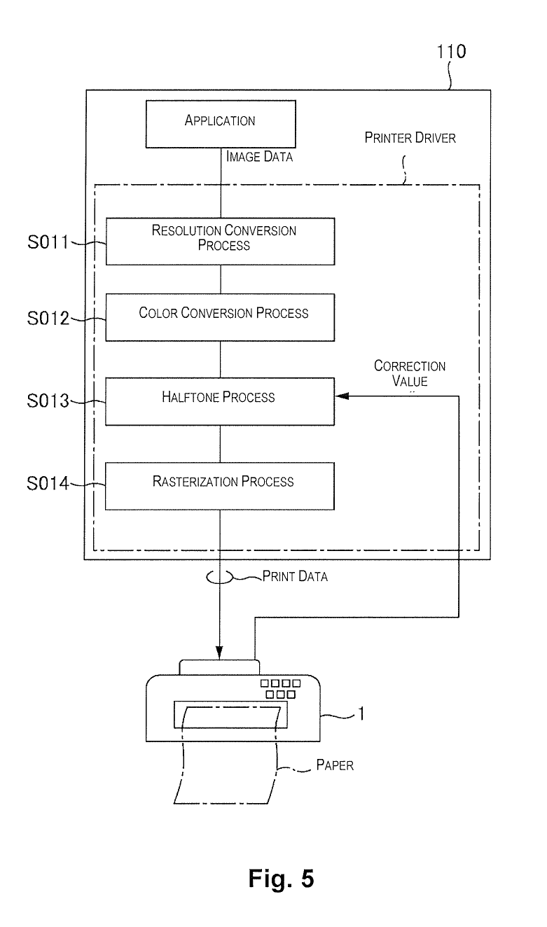

As discussed previously, the aforedescribed printing process starts upon transmission of print data from the computer 110 connected to the printer 1. The print data is generated through processing by the printer driver. Processing by the printer driver is described below while referring to FIG. 5. FIG. 5 is an illustrative diagram of processing by the printer driver.

As shown in FIG. 5, print data is generated through execution of a resolution conversion process (S011), a color conversion process (S012), a halftone process (S013), and a rasterization process (S014) by the printer driver.

First, in the resolution conversion process, the resolution of RGB image data obtained by executing an application program is converted to a print resolution that corresponds to a specified picture quality. Next, in the color conversion process, the resolution-converted RGB image data is converted to CMYK image data. Here, CMYK image data refers to image data of the colors cyan (C), magenta (M), yellow (Y), and black (K). The plurality of pixel data that make up the CMYK image data are respectively represented by tone values having 256 levels. These tone values are defined based on the RGB image data, and herein are also termed directive tone values.

Next, in the halftone process, continuous tone values shown by pixel data constituting the image data are converted to multilevel dot tone values reproducible by the printer 1. That is, the 256-level tone values shown by the pixel data are converted to 4-level dot tone values. Specifically, they are converted to the four levels of a dot tone value of “00” corresponding to no dot, a dot tone value of “01” corresponding to formation of a small dot, a dot tone value of “10” corresponding to formation of a medium dot, and a dot tone value of “11” corresponding to formation of a large dot. Thereafter, having determined a dot generation rate for each dot size, a dither method, y correction, error diffusion method, or the like is utilized to create pixel data whereby the printer 1 can form dispersed dots.

Next, in the rasterization process, in relation to the image data obtained by the halftone process, the dot data (dot tone value data) is modified to a data sequence for transfer to the printer 1. The rasterized data is then sent as part of the print data.

### Minimizing Density Variations

Next, density variations that arise in images printed using the aforedescribed printer 1, and a method for minimizing such density variations, are described.

For the purposes of the following description, “pixel areas” and “row areas” are established. A pixel area indicates an area of rectangular shape hypothetically defined on the paper S, of a size and shape defined according to the print resolution. One “pixel” constituting image data corresponds to one pixel area. A “row area” is an area on the paper S constituted by a plurality of pixel areas lined up in the feed direction. A “pixel row” of pixels lined up in a direction facing the feed direction in the data corresponds to one row area.

### Density Variations

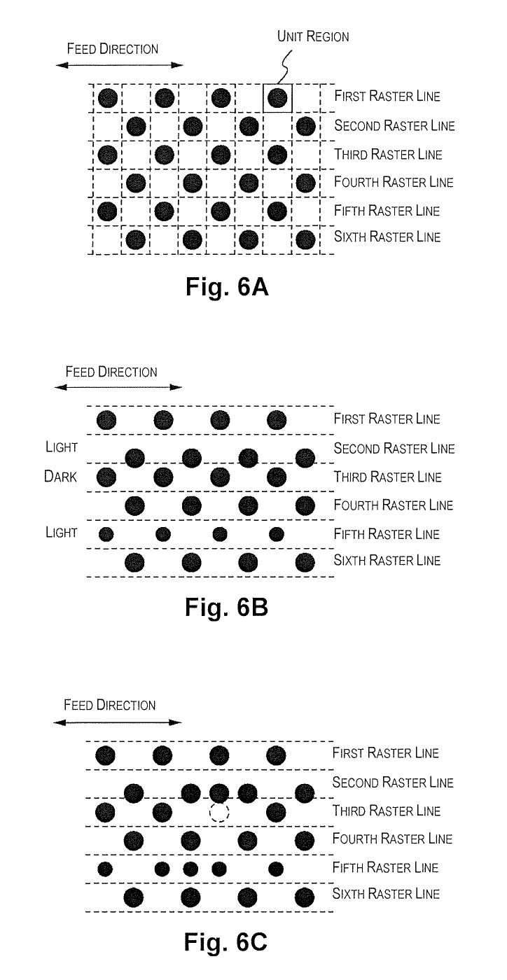

First, density variations will be described while making reference to the drawings. FIG. 6A is an illustrative diagram of ideal formation of dots. Ideal formation of dots means that the ink drops land at the center positions of the pixel areas, and the ink drops spread over the paper S to form dots in the pixel areas. If the dots form properly in the pixel areas, the raster lines (dot rows of dots lined up in the feed direction) will form properly in the row areas.

FIG. 6B is an illustrative diagram of the occurrence of density variations. Due to discrepancies in flight direction of ink drops ejected from nozzles, the raster line that has formed in the second row area is formed with skew toward the third row area. As a result, the second row area is lighter, and the third row area is darker. Additionally, the amount of ink of the ink drops ejected into the fifth row area is less than a prescribed amount of ink, and the dots formed in the fifth row area are smaller. As a result, the fifth row area is lighter.

When a printed image composed of raster lines having such contrasting density differences is viewed on a macroscopic scale, banded density variations are noticeable along the feed direction. Such density variations are a cause of diminished picture quality of printed images.

### Method for Minimizing Density Variations

As one strategy for minimizing density variations of the above kind, it may be contemplated to correct tone values of the pixel data (directive tone values). That is, for a row area that is prone to be noticeably darker, tone values of the pixel data corresponding to a unit region that constitutes the row area are corrected in such a way that the area is formed lighter. Conversely, for a row area that is prone to be noticeably lighter, tone values of the pixel data corresponding to a unit region that constitutes the row area are corrected in such a way that the area is formed darker. Therefore, a concentration correction value H is calculated for correcting the tone values of the pixel data of every raster line. This concentration correction value H is a value that reflects the density variation characteristics of the printer 1.

Once the concentration correction value H has been calculated for every raster line, a process to correct the tone values of the pixel data of every raster line is carried out on the basis of the concentration correction values H, by the printer driver during execution of the halftone process. When the raster lines are formed by tone values corrected by this correction process, as a result of the raster lines in question having undergone density correction, the occurrence of density variations in the printed image is minimized as shown in FIG. 6C. FIG. 6C is a view showing minimized occurrence of density variations.

For example, in FIG. 6C, the tone values of the pixel data of pixels that correspond to the row areas have been corrected in a way that increases the dot generation rate in the second and fifth row areas which are noticeably lighter, and that decreases the dot generation rate in the third row area which is noticeably darker. In this way, the dot generation rates of the raster lines of the row areas are modified to correct the density of image fragments of row areas, and to minimize overall density variations of the printed image.

Calculation of Concentration correction Values H

Next, the process for calculating a concentration correction value H for every raster line (hereinafter termed the correction value acquisition process) is described briefly. The correction value acquisition process is carried out, for example, by a correction value calculation system 200 on the inspection line at the production facility of the printer 1. The correction value calculation system refers to a system for calculating concentration correction values H according to density variation characteristics of the printer 1, and the configuration is generally similar to that of the aforedescribed printing system 100. That is, the correction value calculation system has a printer 1, a computer 110, and a scanner 120 (for convenience, these are denoted with the same symbols as in the printing system 100).

The printer 1 is the machine targeted for the correction value acquisition process, and concentration correction values H for use by the printer 1 are calculated cluing the correction value acquisition process in order that the printer 1 may be used to print images free from density variations. The configuration of the printer 1, and so on, has been described previously and is omitted here. A correction value calculation program for execution of the correction value acquisition process by the computer 110 has been installed on the computer 110 on the inspection line.

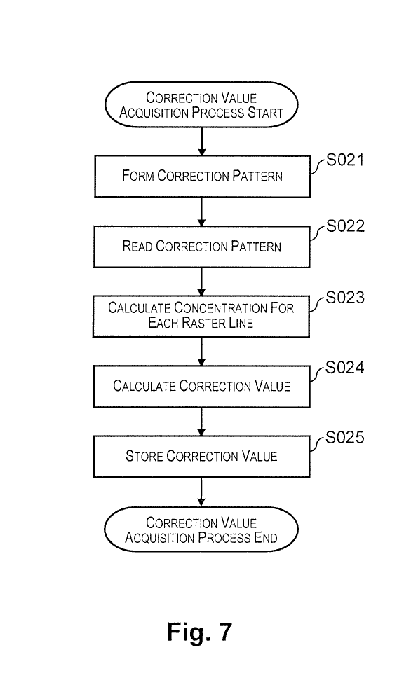

The general routine of the correction value acquisition process is described below while referring to FIG. 7. FIG. 7 is a view showing flow of the correction value acquisition process. Where a printer 1 capable of multicolor printing is targeted as in the present embodiment, the correction value acquisition process is performed by an analogous routine for each ink color. In the following description, the correction value acquisition process for one ink color (e.g., black) is described.

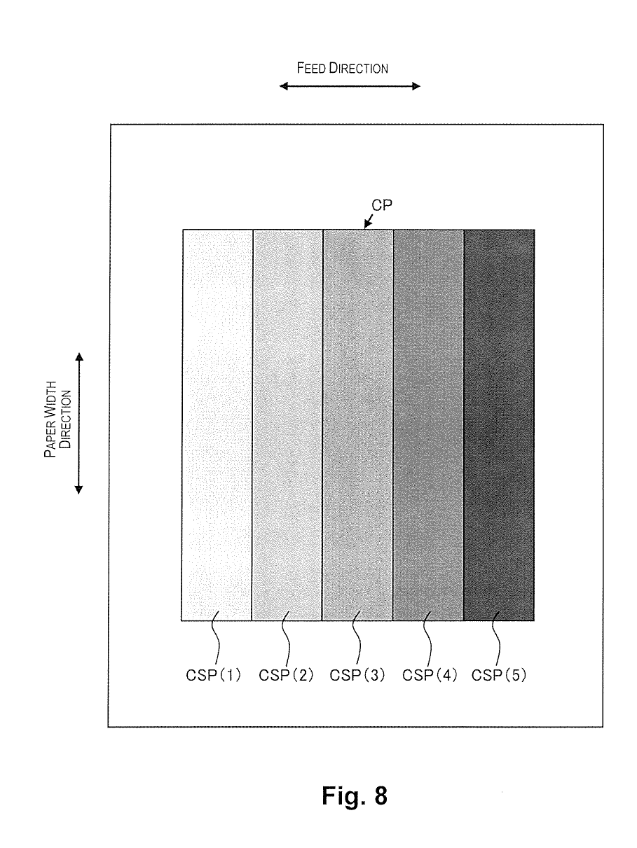

First, the computer 110 sends print data to the printer 1, and by a routine analogous to the printing operation discussed previously, the printer 1 forms a correction pattern CP on the paper S (S021). As shown in FIG. 8, this correction pattern CP is formed by five sub-patterns CSP of different densities. FIG. 8 is an illustrative diagram of the correction pattern CP.

The sub-patterns CSP are patterns of band form composed of a plurality of raster lines along the feed direction lined up in the paper width direction. The sub-patterns CSP are respectively generated from image data of a constant tone value (directive tone value), and as shown in FIG. 8, have progressively darker density in order from the sub-pattern CSP at the left. Specifically, from the left, the sub-pattern densities are 13%, 27%, 40%, 60%, and 86%. Hereinbelow, the directive tone value of the 13% density sub-pattern CSP is denoted as Sa, the directive tone value of the 27% density sub-pattern CSP is denoted as Sb, the directive tone value of the 40% density sub-pattern CSP is denoted as Sc, the directive tone value of the 60% density sub-pattern CSP is denoted as Sd, and the directive tone value of the 86% density sub-pattern CSP is denoted as Se. As shown in FIG. 8, the sub-pattern CSP formed by the directive tone value Sa is denoted as CSP(1). Likewise, the sub-patterns CSP formed by the directive tone values Sb, Sc, Sd, Se are denoted respectively as CSP(2), CSP(3), CSP(4), and CSP(5).

Next, the computer 110 prompts the scanner 120 to scan the correction pattern CP which has been printed onto the paper S, and acquires the result (S022). As mentioned previously, the scanner 120 has three sensors corresponding to R (red), G (green), and B (blue), and irradiates light onto the correction pattern CP, with the light reflected therefrom being detected by the sensors. The computer 110 adjusts the correction pattern on the scanned image data in such a way that the number of pixel rows of pixels lined up in a direction equivalent to the feed direction is the same as the number of raster lines (number of row areas) constituting the correction pattern. That is, the row areas and the pixel rows scanned by the scanner 120 have one-to-one correspondence. The average value of scanned tone values shown by pixels of a pixel row corresponding to a given row area is selected as the scanned tone value for that row area.

Next, on the basis of the scanned tone values acquired by the scanner 120, the computer 110 calculates the density of every raster line (in other words, of every row area) of the sub-patterns CSP (S023). Hereinbelow, density calculated on the basis of the scanned tone values is termed calculated concentration.

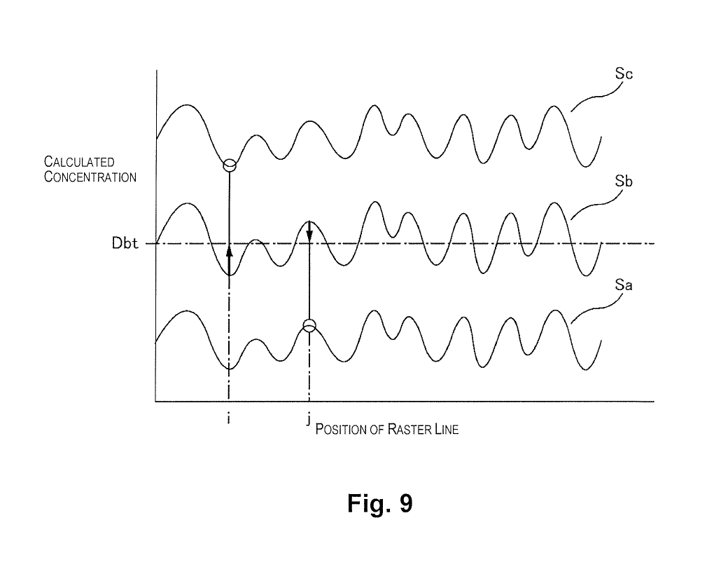

FIG. 9 is a graph showing calculated densities of every raster line for the sub-patterns CSP with the directive tone values of Sa, Sb, and Sc. The horizontal axis in FIG. 9 shows position of raster line, and the vertical axis shows magnitude of calculated concentration. As shown in FIG. 9, despite the fact that the sub-patterns CSP have been formed respectively to have identical directive tone values, contrasting density arises among every raster line. These contrasting density differences of the raster lines are a cause of density variations in the printed image.

Next, from the result scanned by the scanner 120, the computer 110 calculates a concentration correction value H for every raster line (S024). The density correction values H are calculated for every directive tone value. Hereinafter, concentration correction values H calculated for the directive tone values Sa, Sb, Sc, Sd, Se are respectively designated as Ha, Hb, Hc, Hd, and He. In order to describe the calculation routine for the concentration correction values H, an example of a routine for calculating the concentration correction value Hb for the purpose of correcting the directive tone value Sb in such a way that every raster line of the sub-pattern CSP(2) of the directive tone value Sb has a constant calculated density will be described. In the routine in question, for example, an average value Dbt of calculated densities of all of the raster lines in the sub-pattern CSP(2) of the directive tone value Sb is defined as an objective density of the directive tone value Sb. In FIG. 9, for an i-th raster line of calculated concentration lighter than this objective density Dbt, the directive tone value Sb is corrected to make it darker. On the other hand, for a j-th raster line of calculated concentration darker than this objective density Dbt, the directive tone value Sb is corrected to make it lighter.

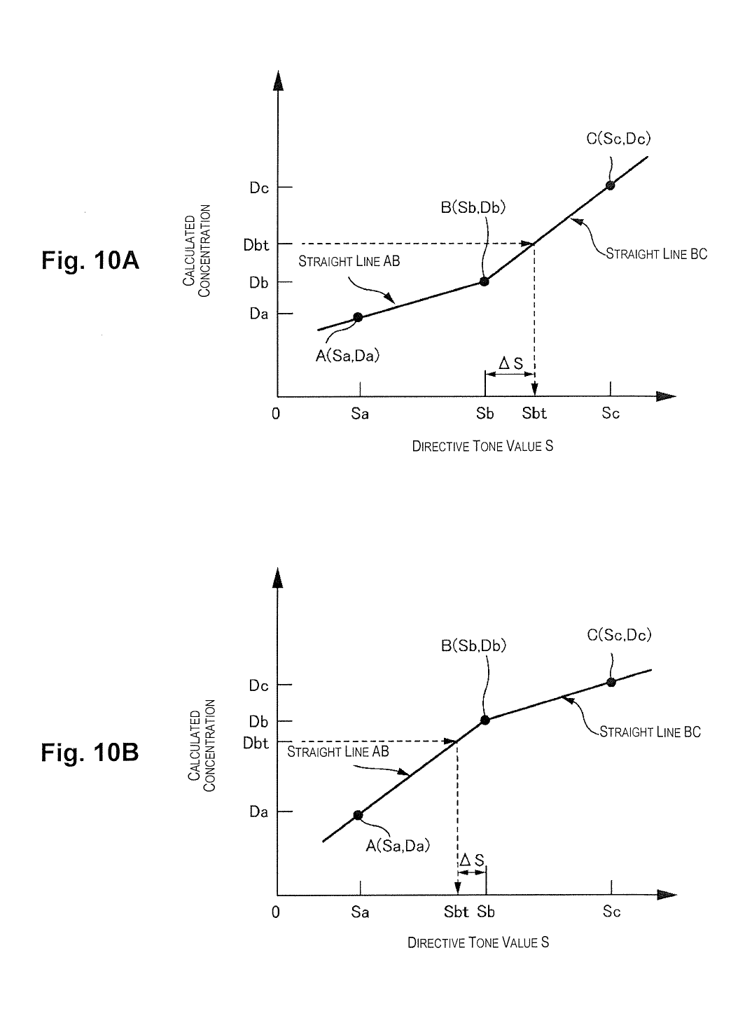

FIG. 10A is an illustrative diagram of a routine for calculating the concentration correction value Hb for the purpose of correcting the directive tone value Sb for the i-th raster line. FIG. 10B is an illustrative diagram of a routine for calculating the concentration correction value Hb for the purpose of correcting the directive tone value Sb for the j-th raster line. In FIGS. 10A and 10B, the horizontal axis shows magnitude of the directive tone value, and the vertical axis shows calculated concentration.

The concentration correction value Hb for the directive tone value Sb of the i-th raster line is calculated on the basis of the calculated concentration Db of the i-th raster line in the sub-pattern CSP(2) of the directive tone value Sb shown in FIG. 10A, and the calculated concentration Dc of the i-th raster line in the sub-pattern CSP(3) of the directive tone value Sc. More specifically, in the sub-pattern CSP(2) of the directive tone value Sb, the calculated concentration Db of the i-th raster line is smaller than the objective density Dbt. In other words, the density of the i-th raster line is lighter than the average density. Assuming that it is desired to form the i-th raster line in question in such a way that the calculated concentration Db of the i-th raster line is equal to the objective density Dbt, using a straight-line approximation from the correspondence relationship (Sb, Db), (Sc, Dc) of the directive tone value and the calculated concentration in the i-th raster line as shown in FIG. 10A, the tone value of the pixel data corresponding to the i-th raster line, i.e., the directive tone value Sb, should be corrected to an objective directive tone value Sbt calculated by Expression (1) below.

Sbt=Sb+(Sc−Sb)×{(Dbt−Db)/(Dc−Db)} (1)

Then, a concentration correction value H for the purpose of correcting the directive tone value Sb for the i-th raster line is derived by Expression (2) below, from the directive tone value Sb and the objective directive tone value Sbt.

Hb=ΔS/Sb=(Sbt−Sb)/Sb (2)

On the other hand, the concentration correction value Hb for the directive tone value Sb of the j-th raster line is calculated on the basis of the calculated concentration Db of the j-th raster line in the sub-pattern CSP(2) of the directive tone value Sb shown in FIG. 10B, and the calculated concentration Da of the j-th raster line in the sub-pattern CSP(1) of the directive tone value Sa. Specifically, in the sub-pattern CSP(2) of the directive tone value Sb, the calculated concentration Db of the j-th raster line is greater than the objective density Dbt. Assuming that it is desired to form the j-th raster line in question in such a way that the calculated concentration Db of the j-th raster line is equal to the objective density Dbt, using a straight-line approximation from the correspondence relationship (Sa, Da), (Sb, Db) of the directive tone value and the calculated concentration in the j-th raster line as shown in FIG. 10B, the directive tone value Sb of the j-th raster line should be corrected to an objective directive tone value Sbt calculated by Expression (3) below.

Sbt=Sb+(Sc−Sa)×{(Dbt−Db)/(Dc−Da)} (3)

Then, the concentration correction value Hb for correcting the directive tone value Sb for the j-th raster line is derived by Expression (2).

In the above manner, for every raster line, the computer 110 calculates a concentration correction value Hb for the directive tone value Sb. Analogously, concentration correction values Ha, Hc, Hd, He for the directive tone values Sa, Sc, Sd, Se are respectively calculated for every raster line. The concentration correction values Ha to He for the directive tone values Sa to Se are respectively calculated for every raster line, for the other ink colors as well.

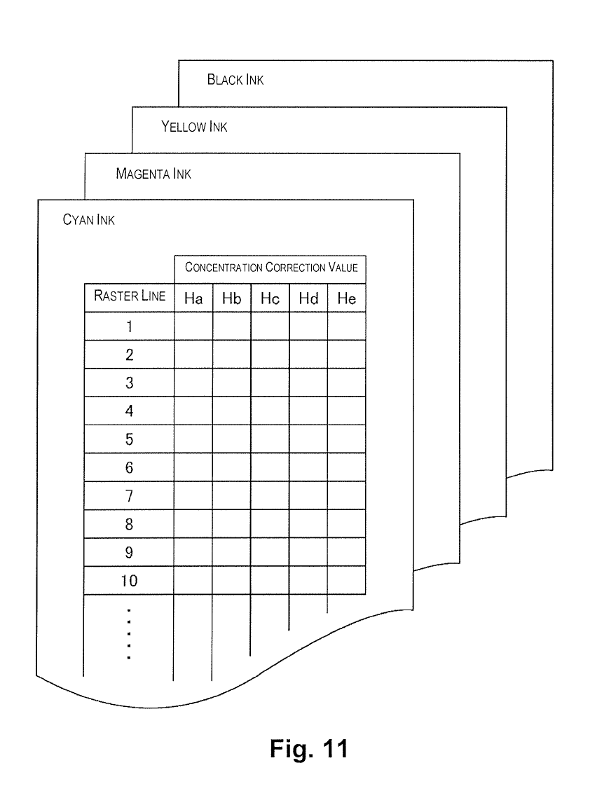

Subsequently, the computer 110 transmits the concentration correction value H data to the printer 1, and stores it in the memory 53 of the printer 1 (S025). As a result, as illustrated in FIG. 11, in the memory 53 of the printer 1 there are created correction value tables (equivalent to correction data) which tabulate concentration correction values Ha to He for each of the five directive tone values Sa to Se for every raster line. FIG. 11 is a diagram showing the correction value tables stored in the memory 53. As shown in FIG. 11, correction value tables are created separately by ink color. As a result, correction value tables for the four colors CMYK are formed. During printing of an image using the printer 1, the printer driver refers to these correction value tables in order to correct tone values of raster lines constituting image data of the image in question. Hereinbelow, concentration correction values H are termed simply concentration correction values.

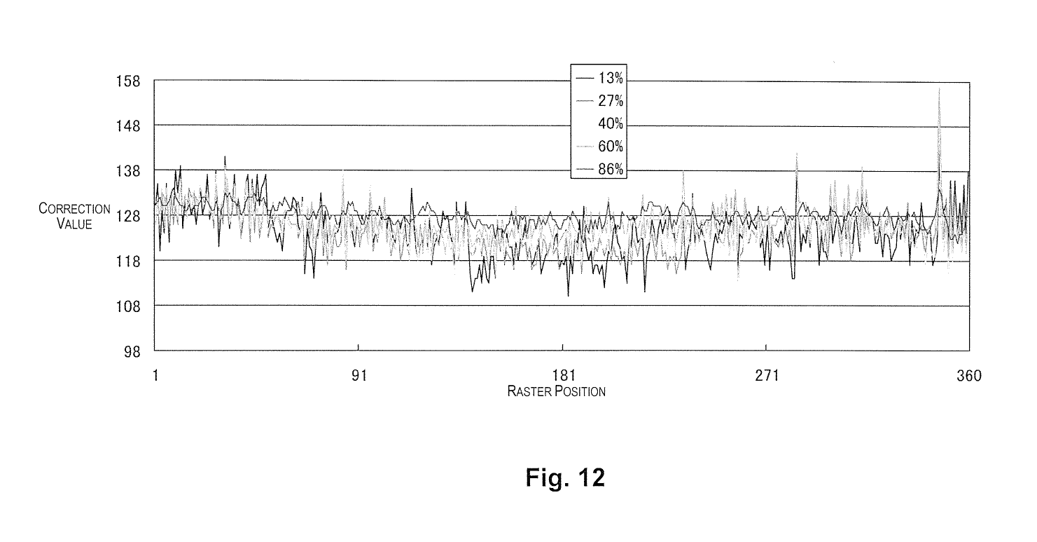

FIG. 12 is a diagram showing an example of data in a correction value table. The horizontal axis in the diagram is raster position (i.e., raster number), and the vertical axis in the diagram is concentration correction value. Here, concentration correction values of every density (every directive tone value) for the first raster line to the 360-th raster line are shown. Here, the average value Dbt in FIG. 9 is 128, and directive tone values are corrected to this density. This means that concentration correction values of 128 in the diagram require no correction (correction is not carried out). It also means that larger concentration correction values bring about darker correction, while smaller values bring about lighter correction. Specifically, in a case of fine line widths (dot widths) (e.g., as with the i-th raster line of FIG. 9), areas without ink coverage (distances between dots) are large, and white streaks tend to stand out, and therefore correction values are defined so as to make them darker (correction values are greater than 128). Conversely, in a case of heavy line widths (e.g., as with the j-th raster line of FIG. 9), there are more areas of overlapping ink coverage and black streaks tend to stand out, and therefore correction values are defined so as to make them lighter (correction values are less than 128).

For example, in FIG. 12, concentration correction values in proximity to the 350-th raster line stand out to a great extent. This means that because density in this raster line is lighter, for reasons such as curving flight path or wide nozzle pitch, a greater concentration correction value is established (correction is darker) as compared with other raster lines. Revision of Concentration correction values

Depending on printing conditions, the way that the ink (dot) spreads out may differ. For example, when printing is carried out under the control of a user, if the printing media are of different types, the sizes of dots (in other words, dot width) formed on media may differ, despite the fact that identical amounts of ink are being ejected from given nozzles. While it is possible to minimize density variations through the use of the correction value tables discussed above, when dot width varies, the form which density variations take will differ, so there is a risk that it will not be possible to minimize density variations, despite using correction value tables created in advance. Because of this, preferred practice would be to provide a plurality of correction value tables for every printing condition (e.g., type of medium). However, creation of correction value tables requires a procedure like that discussed above, and moreover such density variations are particular to each printer. Therefore, creation of correction value tables for every printer and for every type of medium on the inspection line would be time-consuming and laborious. Moreover, greater capacity would be needed in the memory 53 of the printer 1 to store the correction value tables.

Accordingly, in the present embodiment, the line width of raster lines formed on a target printing medium by specific nozzles of the printer 1 during printing is measured by the scanner 120, and concentration correction values in the correction value tables are revised automatically according to the measurement result. More specifically, in cases where the line width measured by the scanner 120 is finer than the line width at creation of the correction value table, ink spread is small, and therefore white streaks stand out. Accordingly, in such cases, the values of the correction value table are revised for darker printing (for greater concentration correction values). Conversely, in cases where the line width measured by the scanner 120 is heavier than the line width at creation of the correction value table, there are more portions of overlapping ink, and black streaks stand out. Accordingly, in such cases, the values of the correction value table are revised for lighter printing (for smaller concentration correction values). However, because the ink used by the printer 1 has the quality of wetting and spreading, the rise in density will be small unless there is a sharp increase in the amount of penetration. That is, even if there are portions where dots overlap, these progressively smooth out, and therefore degradation of picture quality by black streaks is less than in the case of white streaks.

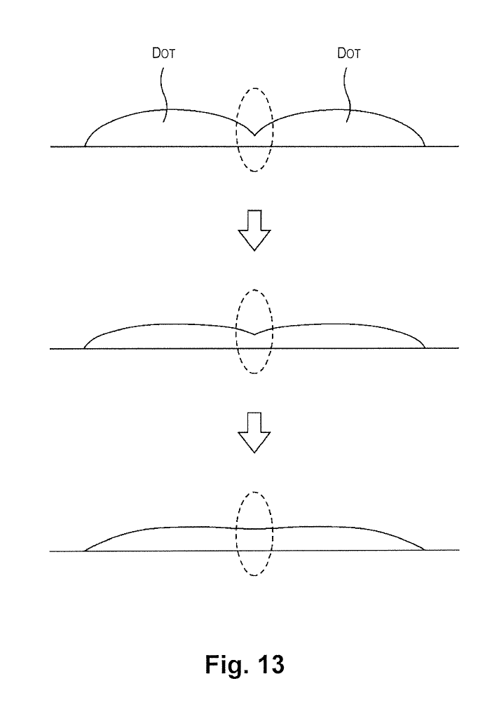

FIG. 13 is a schematic diagram showing wetting and spreading of ink. In the case of heavy line width (width of dots), there is overlap between adjacent dots. However, even where there is overlap between adjacent dots, because they progressively smooth out as shown in the diagram, degradation of picture quality tends not to stand out. In contrast to this, in the case of fine line width, spaces between dots are wider, and white streaks tend to stand out. Therefore, degradation of picture quality is considerable. That is, it is preferable for the amount of revision of concentration correction values when line width is heavier by a predetermined value relative to an objective line width (e.g., the line width at creation of the correction value table) to be smaller than the amount of revision of concentration correction values when line width is lighter by a predetermined value.

The embodiment below describes a case of revision of a correction value table when the raster lines printed onto a target printing medium are fine in line width. Revision for heavy line width could be carried out in analogous fashion.

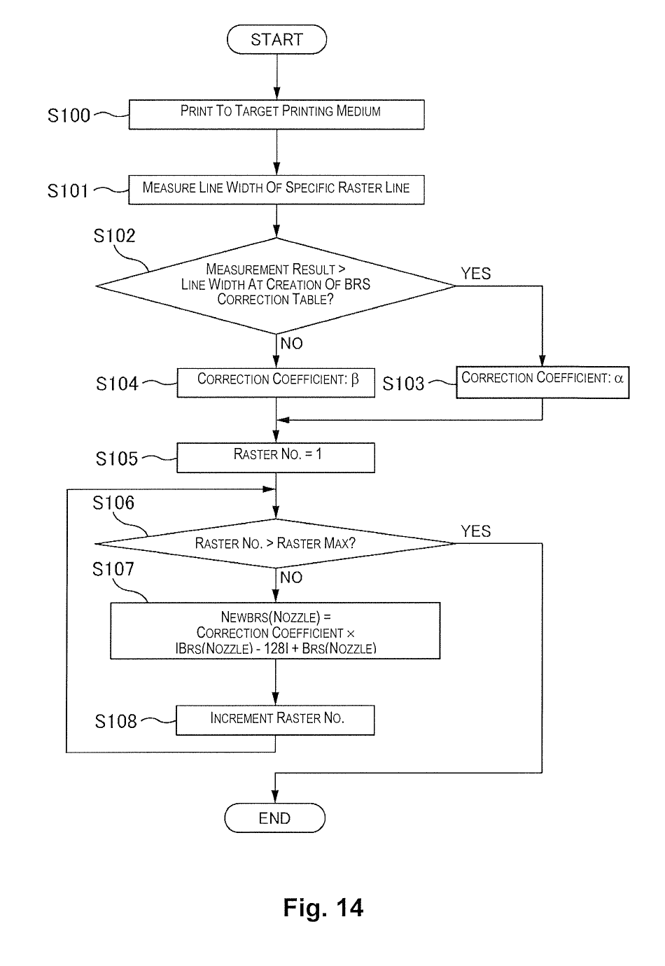

FIG. 14 is a flowchart showing an example of a correction value table revision method according to the present embodiment. The following process is carried out, for example, by the computer 110 controlling the scanner 120 and the printer 1 via the scanner driver and the printer driver of the computer 110, according to a program. In the present embodiment, the line width of a raster line (e.g., the 100th raster line) formed by a specific nozzle at creation of the correction value table is measured by the scanner 120, and the result is stored in the memory 53 of the printer 1. That is, a correction value table, and the line width of the 100th raster line at creation of the correction value table in question, are stored in the memory 53. There is a one-to-one correspondence between nozzles of the printer 1 and raster lines formed on a medium. Also, printing is carried out on several different types of media (target printing media) different from the medium at creation of the correction value table.

First, the target printing media is set in the printer 1. The computer 110 carries out printing of the target printing media by the printer 1 (S100). Thereafter, the computer 110 prompts the scanner 120 to measure the line width of a specific raster line (the 100th raster line) formed on the target printing media (S101). The computer 110 then carries out a comparison of the result of the measurement of line width by the scanner 120, and the line width stored in the memory 53 of the printer 1 (S102). In a case where the line width measurement by the scanner 120 is greater than the line width stored in the memory 53 (YES in S102), a correction coefficient of a is defined (S103). On the other hand, in a case where the line width measurement by the scanner 120 is equal to or less than the line width stored in the memory 53 (NO in S102), a correction coefficient of β is defined (S104). The absolute value of α is less than the absolute value of β (|β|>|α|). In the present embodiment, the correction coefficient α is 0 and the correction coefficient β is 1.2.

From within the correction value table acquired from the printer 1 (see FIG. 11) the computer 110 selects the raster line having the smallest number (the first raster line) (S105), and carries out a decision as to whether the selected raster line is the greatest raster line (S106). Here, because the selected raster line is the first raster line, it is decided to be less than the greatest raster line. In cases where the selected raster line is less than the greatest raster line (NO in S106), the concentration correction value corresponding to that raster line is revised according to the following expression (S107).

newBRS(nozzle)=correction coefficient×|BRS(nozzle)−128|+BRS(nozzle) (4)

BRS(nozzle) denotes the concentration correction value of the raster line corresponding to a nozzle number (nozzl). newBRS(nozzle) denotes a new concentration correction value (revised concentration correction value) in the raster line. The concentration correction value of the first raster line is revised according to this Expression (4).

Specifically, in Step S102, in a case where the line width measured by the scanner 120 is equal to or less than the line width at creation of the BRS correction value table (No in S102), a correction coefficient of β (=1.2) is established. At this time, for a raster line with a concentration correction value of 130 for example, from Expression (4), newBRS(nozzle)=1.2|130−128|+130=132.4. Similarly, for a raster line with a concentration correction value of 120 for example, newBRS(nozzle)=1.2|120−128|+120=129.6. From this it will be appreciated that concentration correction values for raster lines are revised to be darker overall. Additionally, with respect to the average concentration correction value (128), the amount of correction in the case of a concentration correction value of 130 is 2.4, and the amount of correction in the case of a concentration correction value of 120 is 9.6. In this way, the amount of correction increases for raster lines further away from the average. By revising concentration correction values in this way, density variations can be minimized further.

On the other hand, in a case where the line width measured by the scanner 120 is greater than the line width at creation of the BRS correction value table (YES in S102), a correction coefficient of α (=0) is established. At this time, from Expression (4), newBRS(nozzle)=BRS(nozzle), and the correction value is not modified.

Next, the raster line number is incremented (S108), and the decision of Step S106 is carried out once more for the second raster line. Step S106 to Step S108 are executed repeatedly in this way, and when in Step S106 the number of the raster line exceeds the maximum number of raster lines (Yes in S106), the process finishes.

Through the above process, concentration correction values corresponding to raster lines of the correction value table are respectively revised. Then, when printing of this target printing medium is to be carried out, the computer 110 creates print data on the basis of the revised correction value table, and outputs the print data to the printer 1.

Whereas in the present embodiment there are two correction coefficients, three or more correction coefficients could be defined depending on line width.

As described above, in the present embodiment, the line width of a specific raster line at creation of a correction value table is stored, together with the correction value table, in the memory 53 of the printer 1. Also, in the present embodiment, the line width of a specific raster line formed on a target printing medium is measured by the scanner 120. The computer 110 then compares the line width stored in the memory 53 with the line width measured by the scanner 120, and corrects the concentration correction values of the correction value table according to the result of the comparison. In so doing, the correction value table is revised automatically, whereby a correction value table for minimizing density variations can be created while reducing the time and labor involved.

With regard to the timing for execution of the process of FIG. 14, in preferred practice the process will be carried out without fail at startup of the printer 1 under control of the user, and prior to printing on a new medium. Also, there is a possibility that line width will vary during printing as well. This may happen, for example, because ink ejection characteristics are dependent on environmental factors such as temperature and humidity. Accordingly, the temperature of the heads may be monitored, and line width may be measured at timing coincident with exceeding a given temperature. Also, line width may be measured at periodic intervals.

Whereas in the present embodiment the system is comprised of the printer 1, the computer 110, and the scanner 120, it may be comprised of the printer 1 and the scanner 120, or of an integrated unit of all of these.

### Other Embodiments

Whereas a printer or the like was described by way of or embodiment, the aforedescribed embodiment is intended to aid in understanding of the invention, and should not be construed as limiting the invention. Various modifications and improvements are possible without departing from the idea of the invention, and these equivalents are included within the invention. In particular, the embodiments mentioned hereinbelow are understood to be included within the invention.

### Printer

Although the aforedescribed embodiment cites an example of a line head printer with nozzles lined up in a paper width direction intersecting the feed direction of the medium, such an arrangement is not provided by way of limitation. Also acceptable is, e.g., a printer (serial printer) that repeatedly alternates between a dot forming operation for forming a dot row along a direction of movement while a head unit is moved in the direction of movement intersecting the nozzle row direction, and a conveying operation (moving operation) for conveying the paper in a feed direction which is the nozzle row direction.

As regards the ink ejection system for ejecting ink from the nozzles of the printer 1, a piezo system involving expansion and contraction of ink chambers through driving of piezo elements is acceptable, as is a thermal system involving generation of air bubbles inside the nozzles with heating elements, and ejection of ink by the air bubbles.

### Scanner

Although the aforedescribed embodiment uses a scanner 120 of a sensor system having R, G, and B sensors (e.g., CCDs) which acquire RGB color information when reflected light of light irradiating the original is scanned by the sensors, such an arrangement is not provided by way of limitation. For example, a light source switching system in which fluorescent lamps of the colors R, G, and B are sequentially flashed, and the reflected light is scanned by monochrome image sensors to acquire RGB color information; or a filter switching system in which R, G, and B color filters are furnished between a light source and sensors, and these color filters are sequentially switched to acquire RGB color information, is also acceptable. Also, sensors may be furnished on the conveyance path of the medium to scan the image on the medium as it is being conveyed.

Also, line width of raster lines may be measured with a device other than a scanner.

### Heads and Nozzles

The above-described embodiment was furnished with a plurality of heads lined up in a staggered pattern. However, the configuration of the head is not limited to this, and it would be acceptable, for example, to furnish a single head along the paper width direction. In this case, a nozzle row may be configured by disposing a plurality of nozzles along a straight line in the paper width direction.

### Ink

A UV ink that cures upon irradiation with ultraviolet (UV) may be used as the ink. In this case, an irradiator (light source) may be furnished to irradiate the medium with UV during the time between formation of dots (raster lines) and measurement of line width by the scanner 120. Where this sort of UV ink is used, because the dots are cured and fixed on the medium through irradiation with UV, printing can be carried out on media that do not readily absorb ink. However, because the manner of spread of the dots prior to irradiation with UV will differ depending on the type of medium, there are marked differences in density variations between media of different types. In such cases as well, through implementation of the present embodiment, correction value tables adapted to media can be recreated, so that density variations can be minimized. Therefore, implementation of the present embodiment is more effective in cases where UV ink is used.

What is claimed is:

1. A printing device comprising:
a dot formation section having nozzle rows in which a plurality of nozzles line up in a predetermined direction, the dot formation section adapted for ejecting ink from the nozzle rows while bringing about relative movement of the nozzle rows and a medium in a direction of relative movement which intersects the predetermined direction, by forming in the predetermined direction a plurality of dot lines in which a plurality of dots line up in the direction of relative movement;
a detection section that detects dot width in the predetermined direction in a given dot line;
a storage section that stores correction data which defines concentration correction values for dot lines, and dot width of the given dot line in the predetermined direction at the time of creation of the correction data; and
a correction value adjustment section that compares dot width detected by the detection section with dot width stored in the storage section, and respectively correcting concentration correction values in the correction data according to the comparison results.

2. The printing device according to claim 1, wherein
the correction value adjustment section, in cases where a dot width detected by the detection section is greater than a dot width stored in the storage section, corrects the concentration correction values in the correction data such that the dot lines assume lighter density; and in cases where a dot width detected by the detection section is less than a dot width stored in the storage section, corrects the concentration correction values in the correction data such that the dot lines assume darker density.

3. The printing device according to claim 1, wherein
in cases where a dot width detected by the detection section is greater by a predetermined value than a dot width stored in the storage section, the amount of correction of concentration correction values is less than the amount of correction of concentration correction values in cases where a dot width detected by the detection section is less by the predetermined value than a dot width stored in the storage section.

4. The printing device according to claim 1, wherein
the amount of correction of concentration correction values is increased for dot lines having a greater differential between density and an average value of density of a plurality of dot lines formed by the dot formation section.

5. The printing device according to claim 1, wherein
the ink is an ink cured by irradiation with light; and
the printing device further has a light source that irradiates a medium with light prior to detection of dot width of the given dot line by the detection section.

6. A printing method of a printing device having nozzle rows in which a plurality of nozzles line up in a predetermined direction, wherein ink is ejected from the nozzle rows while relative movement of the nozzle rows and a medium is brought about in a direction of relative movement which intersects the predetermined direction, by forming in the predetermined direction a plurality of dot lines in which a plurality of dots line up in the direction of relative movement; wherein the printing method is characterized by comprising:
storing in a storage section correction data which defines concentration correction values for dot lines, and dot width of a given dot line in the predetermined direction at the time of creation of the correction data;
detecting, using a detection section, dot width in the predetermined direction in the given dot line formed on the medium;
comparing dot width detected by the detection section with dot width stored in the storage section, and respectively correcting concentration correction values in the correction data according to the comparison results; and
applying the correction data subsequent to correction and carrying out printing on the medium.
